(19) United States
(12) Patent Application Publication
(10) Pub. No.: US 2004/0152414 A1
(43) Pub. Date: Aug. 5, 2004

(54) Remote control device capable of receiving video signal through a television tuner and displaying the video signal

(76) Inventor: David S. Wang, Newark, CA (US)

Correspondence Address: Sheryl Sue Holloway, BAKELY, SOKOLOFF, TAYLOR & ZAFMAN LLP, Seventh Floor, 12400 Wilshire Boulevard, Los Angeles, CA, 90025-1026, US

(21) Appl. No.: 10/358,533

(22) Filed: Feb. 4, 2003

(51) Int. Cl. H04H 1/00; H04B 7/00

(52) U.S. Cl. 455/3.04; 455/70; 455/92

(57) ABSTRACT

A remote control device for an audio/video system is disclosed. The remote control device is capable of receiving a video signal from a television tuner, the video signal suitable for display on a remote control display, and further capable of displaying the video signal on the remote control display. The remote control device is further capable of receiving an audio signal from the television tuner, and capable of broadcasting the audio signal to a user.

### FIELD OF INVENTION

The present invention relates to a remote controller for an audio/video device. More particularly, the present invention relates to a remote control device capable of receiving a video signal through a television tuner and displaying the video signal.

### BACKGROUND OF THE INVENTION

Television (TV) viewers who want to see “what else is on” typically use either a printed TV guide or an electronic program guide (EPG). Some televisions include a “picture within the picture” feature and/or a “picture-and-picture” feature such that a viewer can find out what the other channels are showing without changing the base channel. A disadvantage of the “picture within the picture” or the “picture-and-picture” features is that the TV screen has to be divided between two channels. Another disadvantage is that the viewer can “turn up” the audio signal (volume) from only one of the two channels at a time to comprehend the audio signal.

The prior art is replete with various remote control devices adapted to communicate with the television. The common functional capabilities for the remote control device may include on/off, volume control and selection control, e.g., channel selection. The prior art fails to appreciate the memory and processing power inherent in the remote control devices. Specifically, the prior art fails to provide for an audio/video communication between the television and the remote control device.

### SUMMARY OF THE INVENTION

A remote control device for an audio/video system is disclosed. The remote control device is capable of receiving a video signal from a television tuner, the video signal suitable for display on a remote control display, and further capable of displaying the video signal on the remote control display. The remote control device is further capable of receiving an audio signal from the television tuner, and capable of broadcasting the audio signal to a user.

### BRIEF DESCRIPTION OF THE FIGURES

The present invention is illustrated by way of example and not limitation in the figures of the accompanying drawings, in which like references indicate similar elements and in which:

FIG. 1 illustrates an exemplary embodiment of an audio/video system which operates in accordance with the teachings of the present invention;

FIG. 2 illustrates another exemplary embodiment of the audio/video system which operates in accordance with the teachings of the present invention;

FIG. 3 illustrates another exemplary embodiment of the audio/video system which operates in accordance with the teachings of the present invention;

FIG. 4 illustrates an exemplary embodiment of a remote control device;

FIG. 5 illustrates another exemplary embodiment of the remote control device;

FIG. 6 illustrates another exemplary embodiment of the remote control device;

FIG. 7 is a flow chart illustrating one embodiment of a method to display media signals received from a television system on a remote display; and

FIG. 8 is a flow chart illustrating one embodiment of a method to transmit media signals to a remote device for display on a remote display.

### DETAILED DESCRIPTION

A hand-held remote control device for an audio/video system is disclosed. In one embodiment, the remote control device includes a receiver, a decoder, a remote control display, such as, for example, a liquid crystal display (LCD), and a user input component. The audio/video system can include a television system including a first tuner and a second tuner. In one embodiment, the television system can receive video and sound (audio) signals and data from sources such as airwaves, cable and satellite. In: another embodiment, the television can receive audio and video signals and data from video and/or audio storage devices including a videocassette recorder (VCR) and a digital video disk (DVD) player. In yet another embodiment, the television can receive audio and video signals from a personal computer (PC) browser in the form of streamed multimedia content. The first tuner can broadcast the audio and video signals through a television display screen. The second tuner can transmit the audio and video signals to the remote control device.

The receiver of the remote control device can receive the audio and video signals transmitted by the second tuner. The decoder can decode the audio and video signals and the LCD can display the visual images of the video signals. Other display technologies may also be used. The user input component can include a touch pad, electromechanical controls, touch screen buttons, and/or a graphical user interface (GUI). The user input component can be used to manipulate the LCD and the television displays.

In one embodiment, the remote control device of the present invention allows the television viewers to watch full screen programming from a particular channel without interruptions while the remote control device user can find out “what else is on” on other channels by viewing programming or a program guide on the LCD of the remote control device.

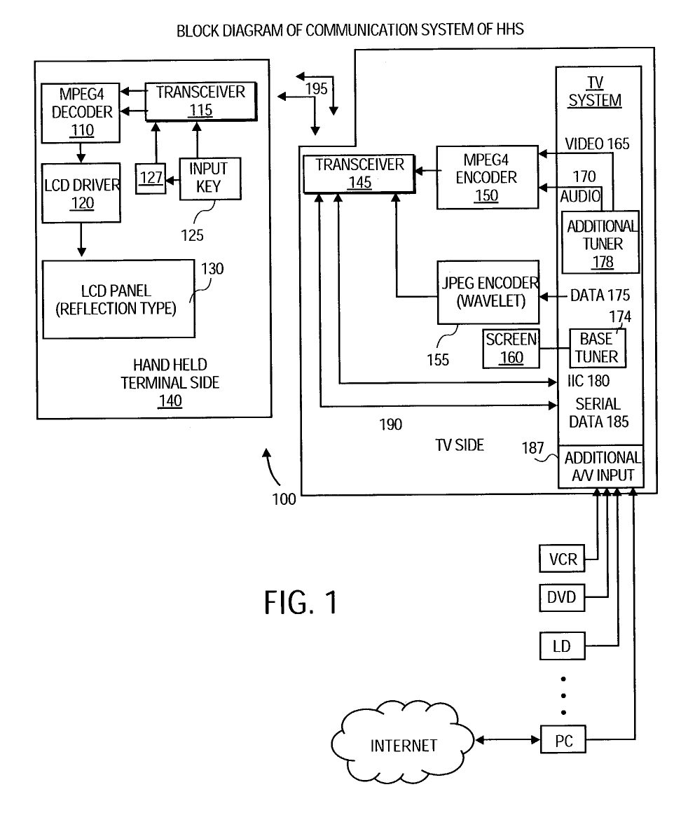

FIG. 1 illustrates an exemplary embodiment of a communication system for the remote control device. Communication system 100 is shown to include the remote control device 140 and the television system 190. The remote control device 140 includes a transceiver module 115 that interfaces to the decoder module 110 and the user input component 125. The decoder 110 is coupled to the liquid crystal display (LCD) driver 120. The LCD driver 120 interfaces to the LCD panel 130. The television system 190 includes the transceiver module 145 that interfaces to the encoders 150 and 155. A transceiver module includes both a transmitter and a receiver.

The encoder 150 is coupled to the additional tuner 178 through the video channel 165 and the audio channel 170. The encoder 150 can receive audio and video signals from the additional tuner 178. In one embodiment, the encoder 150 can include a Moving Pictures Experts Group standard number 4 (MPEG-4) compatible encoder. In another embodiment, the encoder 150 can include a MPEG-2 compatible encoder. In yet another embodiment, the encoder 150 can include a video compression standard H.261/3 compatible encoder. The encoder 150 can encode the audiovisual signal and transmit it to the remote control device 140.

The additional tuner 178 is generally present in most television systems. Additional tuner 178 is popularly referred to as the second tuner. The additional tuner 178 is typically used to facilitate the “picture within the picture” or the “picture-and-picture” or to receive the audio and video signals from storage devices such as, for example, a video cassette recorder (VCR).

The encoder 155 can be coupled to the data source 175. The data source 175 can include the set top box (STB) or a telephone line. The encoder 155 can include a Joint Photographic Experts Group (JPEG) standard compatible encoder. The encoder 155 can receive the electronic program guide (EPG) from the data source 175. The encoder 155 can encode the EPG and transmit it to the remote control device 140.

The television system 190 includes the base tuner 174 to provide audio and video signals to the base television. The video signal can be displayed on the television screen 160.

In one embodiment, the television system 190 further includes an additional audio/video (AN) input 187 to receive audio and video signals from video and/or audio storage devices including, for example, a videocassette recorder (VCR), a digital video disk (DVD) player, and a laser disk (LD) player, or from a personal computer (PC) browser in the form of streamed multimedia content communicated to the PC via the Internet.

The base tuner 174 and the additional tuner 178 can operate independently of each other. In other words, the two tuners 174 and 178 can broadcast the audio and video signals for two different channels simultaneously. This allows one viewer to scan the various television 190 channels via the remote control device display 130 while other viewers can view a particular channel's broadcast on the base television screen 160.

The transceivers 145 and 115 are coupled to each other via the wireless communication media 195. The wireless communication media 195 can include radio frequency (RF), infrared (IR), as well as other types of communication media.

The transceiver 115 is coupled to the decoder 110. In one embodiment, the decoder 110 can be MPEG-4 compatible. In another embodiment, the decoder 110 can be MPEG-2 compatible. In yet another embodiment, the decoder 110 can be H.261/3 standard compatible. The decoder 110 can decode the audio and video signals encoded by the encoders 150 and 155. The decoder 110 is coupled to the LCD 130 via the LCD driver 120.

The transceiver 115 is also coupled to the user input component 125. The user can use the user input component 125 to control the LCD 130 and the television 190. In one embodiment, the user input component 125 can include a touch pad. In another embodiment, the user input component 125 can include electromechanical controls. In yet another embodiment, the user input component 125 can include a graphical user interface (GUI). In yet another embodiment, the user input component 125 can include touch screen buttons. In yet another embodiment, the user input component 125 can include a voice command receiver. In yet another embodiment, the user input component 125 can include a combination of the above.

In the embodiment that includes the voice command receiver, the remote control device 140 can include a converter module 127 to convert a voice command to an IR command. The converter module 127 can be coupled to the voice command receiver 125 and the transceiver 115. The converter module 127 can convert a voice command to an IR signal and transmit the IR signal to the transceiver 115 for transmission to the transceiver 145. The converter module 127 can be embedded inside the transceiver 115.

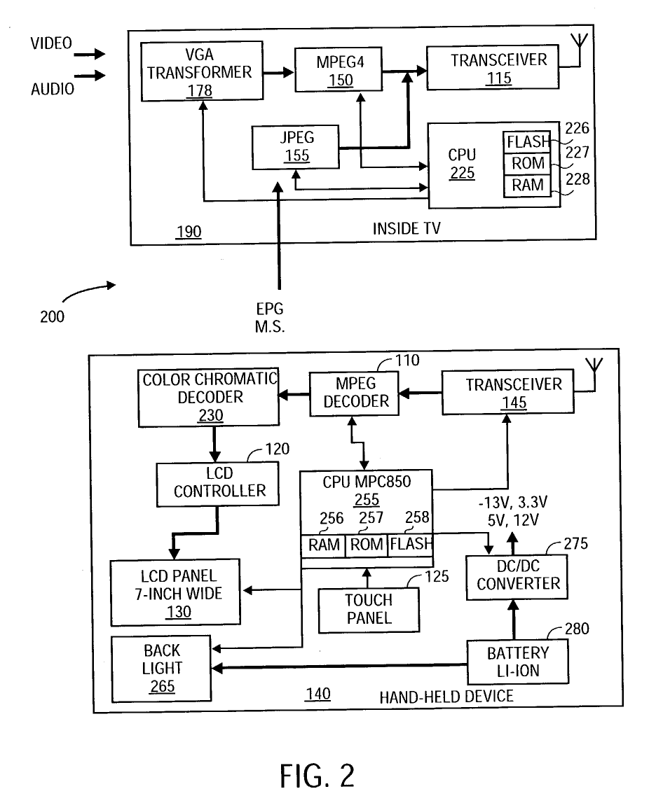

FIG. 2 illustrates another exemplary embodiment of the communication system for the remote control device. The television 190 is shown including a video graphics array (VGA) transformer 178 to receive the audio and video signals from the airwaves, cable, and satellite communication media. The VGA transformer 178 can also be referred to as the additional tuner or the second tuner. The audio and video signals can be analog or digital. The television 190 also includes the encoder 150 to encode the audio and video signals and the encoder 155 to encode the data including the EPG. The encoders 150 and 155 are coupled to the processor 225. The processor 225 can execute the encoding instructions for the encoders 150 and 155. The processor includes storage devices including the flash memory 226, the read-only memory (ROM) 227, and the random access memory (RAM) 228. The encoding instructions can be stored in the storage devices 226, 227 and 228 of the processor 225. The encoded audiovisual signals and data are transmitted to the remote control device 140 through the transceiver 115.

The audio and video signals and data transmitted through the transceiver 115 are received by the transceiver 145 of the remote control device 140. The transceiver 145 is coupled to the decoder 110. The decoder 110 can decode the audio and video signals and data received from the transceiver 145 by using the processor 255. The processor 255 can execute the decode instructions for the decoder 110. The processor 255 can include the storage devices including RAM 256, ROM 257 and FLASH memory 258. The decode instructions can be stored in the processor 255. The processor 255 interfaces the user input component 125 to the LCD 130. The remote control device 140 also includes chromatic decoder 230 coupled to the decoder 110. The chromatic decoder 230 can decode the colors of the video images. The remote control device 140 includes a battery 280 coupled to the voltage converter 275 and the backlight 265. The backlight 265 illuminates the LCD panel 130. The voltage converter 275 recharges the battery 280. The remote control device 140 can include an audio system to broadcast the audio portion of the audio and video signals received from the television 190.

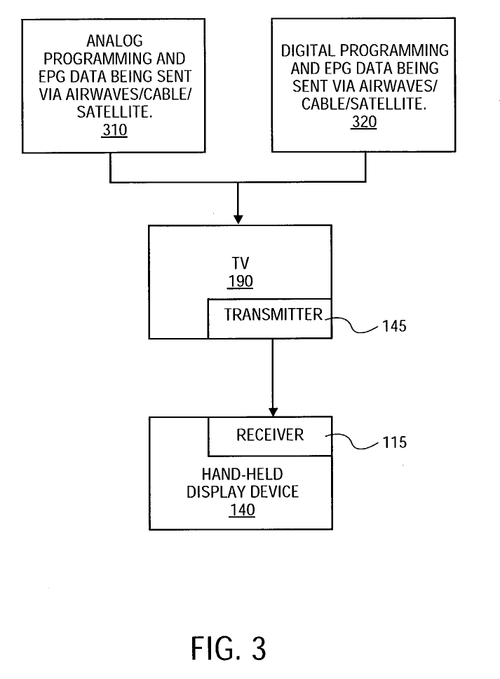

FIG. 3 illustrates another exemplary embodiment of the communication system for the remote control device. The television 190 is shown coupled to an analog source 310 and a digital source 320 of audio and video signals and data. The television 190 can be coupled to the sources 310 and 320 via airwaves, cable, or satellite communication media. The audio and video signals and data received by the television 190 are transmitted to the receiver 115 of the remote control device 140 through the transmitter 145.

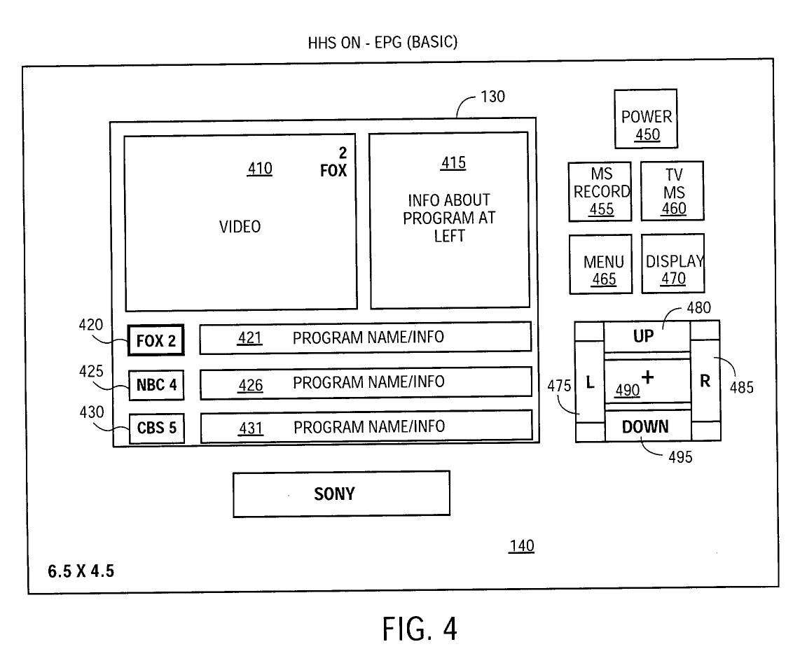

FIGS. 4, 5, and 6 illustrate alternate exemplary embodiments of the remote control device. The remote control device is shown including the LCD 130 and the electromechanical controls 125. It will be appreciated that other types of displays including organic light emitting diodes (OLEDs) and electronic ink can be used instead of the LCD 130.

The electromechanical controls 125 can include the electromechanical buttons including the power 450, record 455, television 460, menu 465, display 470, and up, down, left, right and select 480, 495, 475, 485 and 490. The electromechanical controls 445 can be coupled to the LCD 130 and the transceiver 145 through hardwired circuit components.

The power button 450 can turn on and off the LCD 130 and the television 190. The television button 460 can facilitate the control of the television 190 operation through the remote control device 140. The display button 470 can facilitate the control of the LCD 130 operation through the remote control device 140. The record button 455 can facilitate the display of the EPG on the LCD 130 or the television screen 160. The menu button 465 can facilitate the viewing and selection of various menu items through a GUI that can be viewed via the LCD 130 or the television screen 160. The up, down and select buttons 480, 495 and 490 can perform the channel selector function for the television 190 or the remote control device 140. The up, down, left, right and select buttons 480, 495, 475, 485 and 490 can be used to navigate through and select from the menu items displayed on the LCD 130 or the television screen 160.

The difference between the remote control devices of FIGS. 4, 5 and 6 relates to the manner in which the LCD 130 is shared by the various components. In one embodiment, the remote control device 140 is 6.5 inches long and 4.5 inches high. It will be appreciated that in other embodiments variations in these dimensions are possible. In one embodiment, the LCD 130 is 3.68 inches long and 2.76 inches high. In an alternate embodiment, the LCD 130 has, for example, a 16:9 aspect ratio. It will be appreciated that in other embodiments, countless variations in these dimensions are possible.

Referring to FIG. 4, the LCD is divided among the video component 410, the program information component 415, the channel name components 420, 425 and 430, and the program information components 421, 426 and 431.

The video component 410 can display the video signal received from the second tuner 178 of the television 190. The program information component 415 can display information regarding the video images being displayed on the video component 410, e.g., name of the movie and cast. The channel name components can display the names of television 190 channels and the program information components 421, 426 and 431 can display the names of the television programs being broadcast on those channels.

In one embodiment, the user can use the electromechanical controls 125 to select the channel 420, 425 or 430. The video images for that channel 420, 425 or 430 can be broadcast through the video component 410. It will be appreciate that in another embodiment the channel name components 420, 425 and 430 can include touch screen buttons.

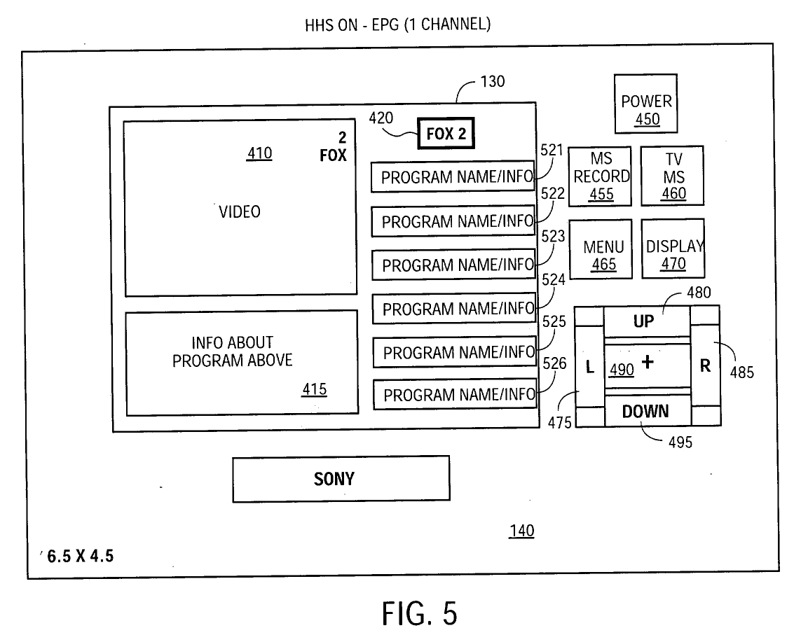

Referring to FIG. 5, the LCD 130 can be divided among the video component 410, the program information component 415, the channel name component 420 and the program information components 421, 522, 523, 524, 525 and 526. The program information components 521, 522, 523, 524 and 525 display program information for only one channel, e.g., for an entire day.

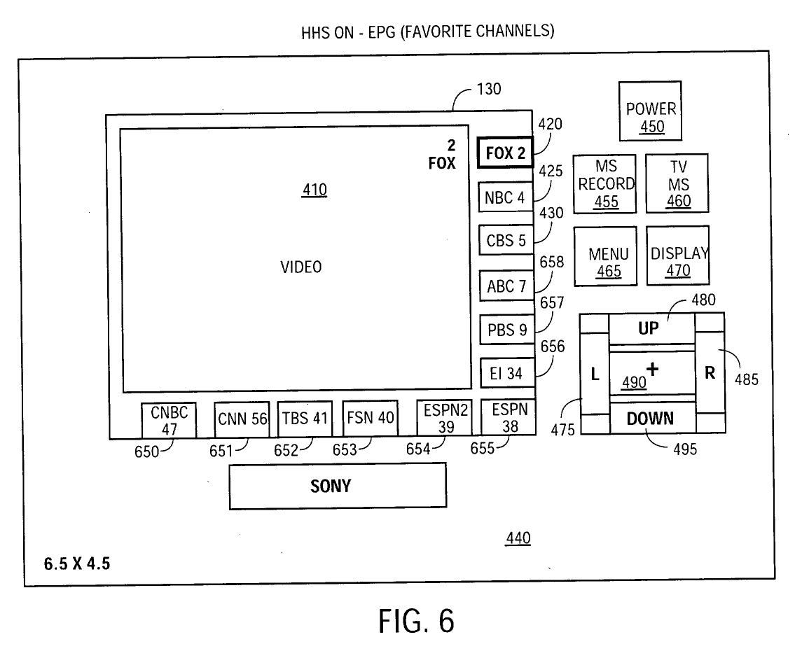

Referring to FIG. 6, the LCD 130 can be divided among the video component 410 and the channel name components 420, 425, 430, 650, 651, 652, 653, 654, 655, 656, 657 and 658. The channel name components 420, 425, 430, 650, 651, 652, 653, 654, 655, 656, 657 and 658 allow the user to select a television 190 channel to be viewed on the LCD 130.

Embodiments of the present invention may be implemented in software programs executed on some form of a processing core (such as a signal processor or a central processing unit of a microprocessor or microcontroller) or otherwise implemented or realized upon or within a machine-readable or computer readable medium. A machine-readable medium includes any mechanism for storing or transmitting information in a form readable by a machine (e.g., a computer or a switch). For example, a machine readable medium includes read-only memory (“ROM”); random-access memory (“RAM”); magnetic disk storage media; optical storage media; flash memory devices; electrical, optical, acoustical, or other form of propagated signals (i.e., carrier waves, infrared signals, digital signals, etc.); or any other type of media suitable to store or to transmit information.

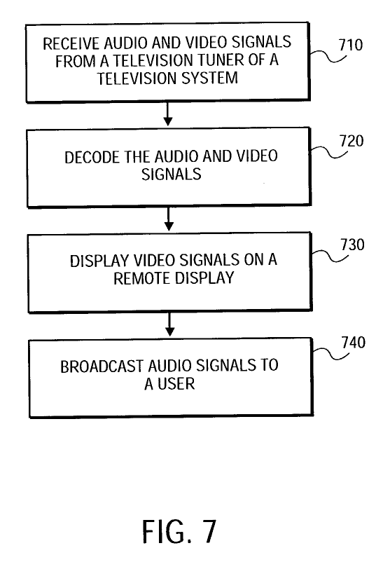

FIG. 7 is a flow chart illustrating one embodiment of a method to display media signals received from a television system on a remote display. As illustrated in FIG. 7, at processing block 710, video signals suitable for display on a remote display and audio signals suitable for broadcasting to a user are received from a television tuner of a television system. At processing block 720, the audio and video signals are decoded. At processing block 730, the video signals are displayed on the remote display. Finally, at processing block 740, the audio signals are broadcasted to the user.

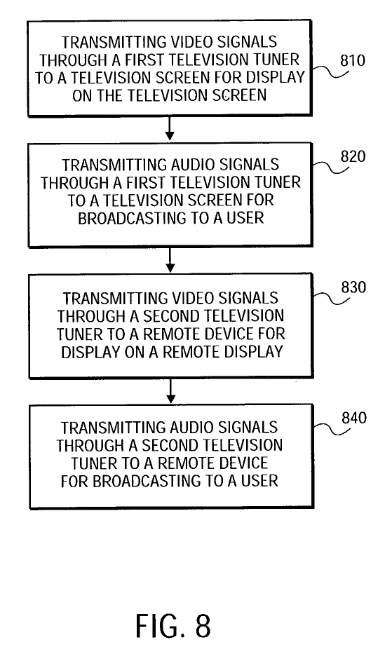

FIG. 8 is a flow chart illustrating one embodiment of a method to transmit media signals to a remote device for display on a remote display. As illustrated in FIG. 8, at processing block 810, video signals are transmitted through a first television tuner to a television screen for display on the television screen. At processing block 820, audio signals are transmitted through the first television tuner to the television screen for broadcasting to a user. At processing block 830, video signals are transmitted through a second television tuner to a remote device for display on a remote display. Finally, at processing block 840, audio signals are transmitted through the second television tuner to the remote device for broadcasting to the user.

The particular methods of the invention have been described in terms of software with reference to a series of flowcharts. The methods to be performed by a computer or machine constitute programs made up of machine-executable instructions illustrated as blocks (acts). It will be appreciated that more or fewer processes may be incorporated into the methods as described above without departing from the scope of the invention, and that no particular order is implied by the arrangement of blocks shown and described herein.

In this specification, the invention has been described with reference to specific exemplary embodiments thereof. It is, however, evident that various modifications and changes may be made thereto without departing from the broader spirit and scope of the invention as set forth in the appended claims. For example, although the invention has been described with reference to a remote control device for a television, it is evident that the invention is relevant to a remote control device for any audio/video system that includes first and second tuners or can be coupled to a television with first and second tuners. The specification and drawings are, accordingly, to be regarded in an illustrative rather than a restrictive sense.

What is claimed is:

1. A remote control device for an audio/video system capable of receiving a video signal from a television tuner, the video signal suitable for display on a remote control display, and further capable of displaying the video signal on the remote control display.

2. The remote control device of claim 1, wherein the remote control device is capable of receiving an audio signal from the television tuner, and further capable of broadcasting the audio signal to a user.

3. The remote control device of claim 1, wherein the remote control display is a liquid crystal display (LCD).

4. The remote control device of claim 1, wherein the audio/video system further comprises at least one audio/video storage device coupled to a television system.

5. The remote control device of claim 4, wherein the at least one audio/video storage device is selected from a group consisting of a videocassette recorder (VCR), a digital video disk (DVD) player, a laser disk (LD) player, and a personal computer (PC).

6. The remote control device of claim 4, wherein the television system further comprises a first tuner to transmit video signals suitable for display on a television screen of the television system and audio signals suitable for broadcasting to a user and a second tuner to transmit video signals suitable for display on the remote control display of the remote control device and audio signals suitable for broadcasting to the user.

7. The remote control device of claim 1, wherein the remote control device further comprises a hand-held device.

8. The remote control device of claim 1, wherein the remote control device is compatible with the Moving Pictures Experts Group standard number 4 (MPEG-4).

9. The remote control device of claim 1, wherein the remote control device is capable of receiving an electronic program guide, and further capable of displaying the electronic program guide on the remote control display.

10. The remote control device of claim 1, wherein the remote control device can operate as a channel selector for a television screen and for the remote control display.

11. The remote control device of claim 1, wherein the remote control device further comprises at least one user input component selected from a group consisting of a touch pad, an electromechanical control button, a graphical user interface, a touch screen button, and a voice command receiver.

12. The remote control device of claim 1, wherein the remote control device communicates with the television system through an infrared communication medium.

13. The remote control device of claim 11, wherein the at least one user input component is a voice command receiver and wherein the remote control device further comprises a converter module to convert a voice command received through the voice command receiver to an infrared signal.

14. An audio/video system comprising:
a television system including a first tuner and a second tuner; and
a remote control device coupled to the television system,
the first tuner to transmit a first video signal suitable for display on a television screen,
the second tuner to transmit a second video signal suitable for display on the remote control device,
the remote control device to receive and display the second video signal on a remote control display.

15. The audio/video system of claim 14, wherein the remote control device is capable of receiving an audio signal through the second tuner, and further capable of broadcasting the audio signal to a user.

16. The audio/video system of claim 14, wherein the remote control display is a liquid crystal display (LCD).

17. The audio/video system of claim 14, wherein the remote control device is a hand-held device.

18. The audio/video system of claim 14, wherein the remote control device is compatible with the Moving Pictures Experts Group standard number 4 (MPEG-4).

19. The audio/video system of claim 14, wherein the second video signal further comprises an electronic program guide (EPG).

20. The audio/video system of claim 14, wherein the remote control device can operate as a channel selector for a television screen within the television system and for the remote control display of the remote control device.

21. The audio/video system of claim 14, wherein the remote control device further comprises at least one user input component selected from a group consisting of a touch pad, an electromechanical control button, a graphical user interface, a touch screen button, and a voice command receiver.

22. The audio/video system of claim 14, further comprising at least one audio/video storage device coupled to the television system, the at least one audio/video storage device being selected from a group consisting of a videocassette recorder (VCR), a digital video disk (DVD) player, a laser disk (LD) player, and a personal computer (PC).

23. The audio/video system of claim 14, wherein the remote control device communicates with the television system through an infrared communication medium.

24. The audio/video system of claim 21, wherein the at least one user input component is a voice command receiver and wherein the remote control device further comprises a converter module to convert a voice command received through the voice command receiver to an infrared signal.

25. A remote control device for an audio/video system comprising:
means for receiving a video signal from a television tuner, the video signal suitable for display on a remote control display; and
means for displaying the video signal.

26. The remote control device of claim 25, wherein the remote control display is a liquid crystal display (LCD).

27. The remote control device of claim 25, further comprising:
means for receiving an audio signal from the television tuner; and
means for broadcasting the audio signal to a user.

28. The remote control device of claim 25, further comprising:
means for receiving an electronic program guide; and
means for displaying the electronic program guide on the remote control display.

29. A method comprising:
receiving a video signal from a television tuner of a television system, the video signal being suitable for display on a remote display; and
displaying the video signal on the remote display.

30. The method according to claim 29, further comprising:
receiving an audio signal from the television tuner; and
broadcasting the audio signal to a user.

31. The method according to claim 29, wherein the remote display is a liquid crystal display (LCD).

32. The method according to claim 30, wherein the video signal and the audio signal are received from an audio/video communication medium.

33. The method according to claim 30, wherein the video signal and the audio signal are received from at least one audio/video storage device.

34. The method according to claim 33, wherein the at least one audio/video storage device is selected from a group consisting of a videocassette recorder (VCR), a digital video disk (DVD) player, a laser disk (LD) player, and a personal computer (PC).

35. The method according to claim 29, wherein the video signal further comprises an electronic program guide (EPG) suitable for display on the remote display.

36. A method comprising:
transmitting a first video signal through a first television tuner to a television screen, the first video signal being suitable for display on the television screen; and
transmitting a second video signal through a second television tuner to a remote device, the second video signal being suitable for display on a remote display of the remote device.

37. The method according to claim 36, wherein the remote display is a liquid crystal display (LCD).

38. The method according to claim 36, wherein the remote device is a hand-held remote control device.

39. The method according to claim 36, further comprising:
transmitting an audio signal through the second television tuner to the remote device for broadcasting the audio signal to a user.

40. The method according to claim 36, further comprising:
receiving the second video signal from an audio/video communication medium.

41. The method according to claim 36, further comprising:
receiving the second video signal from an audio/video storage device.

42. The method according to claim 41, wherein the audio/video storage device is selected from a group consisting of a videocassette recorder (VCR), a digital video disk (DVD) player, a laser disk (LD) player, and a personal computer (PC).

43. An apparatus comprising:
a remote display; and
a transceiver module coupled to the display to receive a video signal from a television tuner of a television system, the video signal being suitable for display on the remote display.

44. The apparatus according to claim 43, further comprising a decoder module coupled to the transceiver module to decode the video signal for display on the remote display.

45. The apparatus according to claim 44, wherein the transceiver module further receives an audio signal from the television tuner and broadcasts the audio signal to a user.

46. The apparatus according to claim 45, wherein the decoder module further decodes the audio signal for broadcasting to the user.

47. The apparatus according to claim 44, further comprising:
at least one user input component coupled to the transceiver module to receive user inputs to control the remote display.

48. The apparatus according to claim 47, wherein the at least one user input component is selected from a group consisting of a touch pad, an electromechanical control button, a graphical user interface, a touch screen button, and a voice command receiver.

49. A computer readable medium containing executable instructions, which, when executed in a processing system, cause the processing system to perform a method comprising:
receiving a video signal from a television tuner of a television system, the video signal being suitable for display on a remote display; and
displaying the video signal on the remote display.

50. The computer readable medium according to claim 49, wherein said method further comprises:
receiving an audio signal from the television tuner; and
broadcasting the audio signal to a user.

51. A computer readable medium containing executable instructions, which, when executed in a processing system, cause the processing system to perform a method comprising:
transmitting a first video signal through a first television tuner to a television screen, the first video signal being suitable for display on the television screen; and
transmitting a second video signal through a second television tuner to a remote device, the second video signal being suitable for display on a remote display of the remote device.

52. The computer readable medium according to claim 51, wherein said method further comprises:
transmitting an audio signal through the second television tuner to the remote device for broadcasting the audio signal to a user.

53. The computer readable medium according to claim 51, wherein said method further comprises:
receiving the second video signal from an audio/video communication medium.

54. The computer readable medium according to claim 51, wherein said method further comprises:
receiving the second video signal from an audio/video storage device.
